(19) United States
(12) Patent Application Publication
(10) Pub. No.: US 2018/0375083 A1
(43) Pub. Date: Dec. 27, 2018

(54) NONAQUEOUS ELECTROLYTE SECONDARY BATTERY

(71) Applicant: PANASONIC INTELLECTUAL PROPERTY MANAGEMENT CO., LTD., Osaka (JP)

(72) Inventors: Takahiro Takahashi, Osaka (JP); Tomoki Shiozaki, Osaka (JP); Yuji Oura, Osaka (JP)

(73) Assignee: PANASONIC INTELLECTUAL PROPERTY MANAGEMENT CO., LTD., Osaka (JP)

(21) Appl. No.: 16/054,262

(22) Filed: Aug. 3, 2018

Related U.S. Application Data
(63) Continuation of application No. PCT/JP2017/001305, filed on Jan. 17, 2017.

(30) Foreign Application Priority Data
Feb. 29, 2016 (JP) 2016-038011

(51) Int. Cl. H01M 2/26; H01M 10/0587; H01M 4/13; H01M 4/36; H01M 4/62; C09J 7/30

(52) U.S. Cl. CPC H01M 2/26; H01M 10/0587; H01M 4/13; H01M 2004/028; H01M 4/62; C09J 7/30; C09J 2479/08; H01M 4/366

(57) ABSTRACT

A nonaqueous electrolyte secondary battery includes an insulating tape which covers at least a portion of an exposed portion of a current collector, together with at least a portion of a lead. The insulating tape has a substrate layer and a first adhesive layer, and the substrate layer has a first organic layer and a second organic layer interposed between the first organic layer and the first adhesive layer. The elastic modulus E1 of the first organic layer is lower than the elastic modulus E2 of the second organic layer.

### TECHNICAL FIELD

The present invention relates to a nonaqueous electrolyte secondary battery and particularly relates to a nonaqueous electrolyte secondary battery having a high energy density.

### BACKGROUND ART

In recent years, the mass of power generation elements filled in a case having a limited volume has continued to increase with progressing increases in energy densities of nonaqueous electrolyte secondary batteries. Accordingly, the pressure applied to electrodes in a case has been increased. Therefore, it has become of increased importance to suppress the occurrence of an internal short-circuit starting from an exposed portion of a current collector. The exposed portion of the current collector is formed as a lead connection region.

Patent Literature 1 describes that an exposed portion of a positive electrode current collector is covered with an insulating protective tape. Also, Patent Literature 2 proposes that heat-sealability is imparted to an adhesive layer of an insulating tape used in a battery. A resin film is often used as a substrate layer of the insulating tape.

### CITATION LIST

### Patent Literature

PTL 1: Japanese Published Unexamined Patent Application No. 2014-89856

PTL 2: Japanese Published Unexamined Patent Application No. 2013-149603

### SUMMARY OF INVENTION

When the pressure applied to an electrode is increased with an increase in energy density of a battery, the possibility of occurrence of internal short-circuits is increased even when a minute foreign material is mixed in the battery. Therefore, in order to decrease the possibility of short circuits, it is desired to use a resin film having satisfactory cushioning properties as a substrate layer of an insulating tape and to deform the substrate layer along the shape of a foreign material. However, the shape and size of the foreign material mixed in the battery cannot be strictly estimated.

On the other hand, when an unexpected foreign material is mixed in a battery with an increased energy density, heat generation by the extension of internal short-circuit becomes significant. Therefore, there is a need for sufficient measures against the unexpected foreign material. However, with an excessively increase in thickness of the resin film having high cushioning properties, the energy density of a battery is decreased, while with an insufficient thickness of the resin film, the foreign material easily pierces the resin film.

In consideration of the above, a nonaqueous electrolyte secondary battery according to an aspect of the present disclosure includes a first electrode having a first current collector and a first active material layer supported by the first current collector, a second electrode having a second current collector and a second active material layer supported by the second current collector, a separator interposed between the first electrode and the second electrode, a nonaqueous electrolyte, a first lead electrically connected to the first electrode, and an insulating tape which covers a portion of the first electrode. The first current collector has an exposed portion which does not support the first active material layer, and the first lead is connected to the exposed portion and has a lead-out portion projecting from the exposed portion and an overlapping portion overlapping the exposed portion. At least a portion of the exposed portion of the first current collector, together with at least a portion of the overlapping portion of the first lead, is covered with the insulating tape. The insulating tape has a substrate layer and a first adhesive layer, and the substrate layer has a first organic layer and a second organic layer interposed between the first organic layer and the first adhesive layer. The elastic modulus E1 of the first organic layer is lower than the elastic modulus E2 of the second organic layer.

According to the present disclosure, even when a foreign material having an unexpected shape or size is mixed in a nonaqueous electrolyte secondary battery with a high energy density, the possibility of occurrence of an internal short-circuits due to the foreign material is decreased.

### BRIEF DESCRIPTION OF DRAWINGS

FIG. 1 is a plan view of a principal portion of a positive electrode according to an embodiment of the present invention.

FIG. 2 is a sectional view of the principal portion of the positive electrode shown in FIG. 1, as viewed from arrows II-II.

FIG. 3 is a sectional view of an insulating tape according to an embodiment of the present invention.

FIG. 4 is a longitudinal sectional view of a cylindrical nonaqueous electrolyte secondary battery according to an embodiment of the present invention.

### DESCRIPTION OF EMBODIMENTS

A nonaqueous electrolyte secondary battery according to an embodiment of the present invention includes a first electrode having a first current collector and a first active material layer supported by the first current collector, a second electrode having a second current collector and a second active material layer supported by the second current collector, a separator interposed between the first electrode and the second electrode, a nonaqueous electrolyte, a first lead electrically connected to the first electrode, and an insulating tape which covers a portion of the positive electrode. Each of the first electrode and the second electrode may be a strip-shaped electrode or a flat plate-shaped electrode. The battery may be a wound type or a laminated type.

The first current collector has an exposed portion which does not the support the first active material layer, and the first lead is connected to the exposed portion. The exposed portion may be formed in any part of the first current collector.

The first lead has a lead-out portion projecting from the exposed portion and an overlapping portion overlapping the exposed portion. The lead-out portion is connected to a first terminal serving as an external terminal or to a battery internal component conductive with the first terminal. At least a portion of the overlapping portion is welded to the exposed portion or bonded to the exposed portion with a conductive bonding material.

The insulating tape covers at least a portion of the exposed portion of the first current collector together with at least a portion of the overlapping portion of the first lead. The insulating tape can suppress a short circuit between the exposed portion of the first current collector and the second active material layer.

The insulating tape has a substrate layer and a first adhesive layer. The substrate layer has a first organic layer and a second organic layer interposed between the first organic layer and the first adhesive layer. Both the first organic layer and the second organic layer have a film form. The first adhesive layer contains an adhesive and has the role of adhering the insulating tape to the exposed portion or the like of the current collector. A second adhesive layer may be further provided between the first organic layer and the second organic layer. The second adhesive layer contains an adhesive and has the role of bonding together the first organic layer and the second organic layer.

In consideration of progressing increases in energy densities of batteries, it is necessary to design the insulating tape with paying sufficient attention that safety is secured when an unexpected foreign material is mixed in the battery.

In this point, the elastic modulus E1 of the first organic layer is lower than the elastic modulus E2 of the second organic layer. That is, the outer side (surface side not having the first adhesive layer) of the substrate layer is coated with the first organic layer having high cushioning properties, and the strong second organic layer with a high elastic modulus is disposed on the inner side near the surface of the first electrode.

In the occurrence mechanism of an internal short circuit involving the insulating tape, it is difficult to estimate that a foreign material first enters between the first adhesive layer and the surface of the first electrode. The foreign material is considered to first pierce the first organic layer disposed on the outer side and reach the first adhesive layer. In this case, the compressive stress by the foreign material is strongly applied to the first organic layer, but is relaxed by piercing through the first organic layer. However, even with relaxation of the compressive stress, when the foreign material piercing through the first organic layer immediately reaches the first adhesive layer, the sharp edge of the foreign material easily passes through the first adhesive layer and reaches the surface of the first electrode, thereby causing an internal short circuit.

On the other hand, when the strong second organic layer with a high elastic modulus is present on the inner side of the first organic layer, the foreign material piercing through the first organic layer cannot apply, to the second organic layer, a compressive stress enough to pierce through the second organic layer and is thus inhibited from reaching the first adhesive layer. Therefore, the probability of occurrence of an internal short-circuit is significantly decreased.

The contact between the edge of the strong second organic layer and the surface of the first electrode may cause the breakage of the first electrode. The breakage of the first electrode degrades the performance of the battery, but violent heat generation can be inhibited by an at least partial interruption of current. Thus, safety can be secured.

Here, the elastic modulus E1 and elastic modulus E2 are, for example, tensile modulus (Young's modulus) at 20° C. The tensile modulus can be determined according to the method described in JIS K7161. In this case, the elastic modulus E2 is preferably 200 to 2000 kgf/mm². The elastic modulus E1 is preferably 10 to 180 kgf/mm². In addition, in order to exhibit, in a well-balanced manner, the cushioning properties of the first organic layer and the effect of inhibiting a short-circuit portion by the second organic layer, the E2/E1 ratio is preferably 2 to 200.

In consideration of the secured cushioning properties, the melting point or thermal decomposition temperature (MP1) of the first organic layer is preferably, for example, 100° C. to 200° C. The melting point or thermal decomposition temperature (MP2) of the second organic layer is preferably as high as possible. However, MP2 is preferably, for example, 300° C. to 700° C. because excessively high MP2 results in excessively high elastic modulus E2 and increases the probability of breaking the positive electrode. In order to exhibit, in a well-balanced manner, the cushioning properties of the first organic layer and the effect of suppressing a short-circuit portion by the second organic layer, a temperature difference ΔT between MP1 and MP2 may be, for example, 100° C. to 600° C.

When large tension is applied to the electrode, an internal short circuit easily occurs. Therefore, when each of the first electrode and the second electrode is a strip-shaped electrode and the battery is a wound type, the insulating tape exhibits the particularly significant effect of suppressing an internal short-circuit. The wound-type battery may be a cylindrical battery having a circular sectional shape perpendicular to the winding axis or a prismatic battery having a flat-rectangular or nearly elliptic sectional shape.

In the wound-type battery, the first electrode and the second electrode are wound with the separator interposed therebetween, forming an electrode group. The electrode group, together with the nonaqueous electrolyte, is housed in a battery case. In the battery with a high energy density, the cross-sectional area S1 of the electrode group and the cross-sectional area S2 of a region (hollow region) surrounded by the inner peripheral surface of the battery case satisfy, for example, 0.95≤S1/S2, and may satisfy 0.97≤S1/S2. The upper limit of the S1/S2 ratio is 1, and as the S1/S2 ratio approaches 1, the battery case is filled with power generation elements at a high density. Therefore, the tension applied to each of the electrodes is increased, thereby increasing the necessity of suppressing an internal short circuit. The cross-sectional area is the area of a section of the electrode group or hollow region perpendicular to the winding axis.

More specifically, S1 represents the area surrounded by the outline of the outer periphery in a section perpendicular to the winding axis of the electrode group. A difference between S1 and S2 becomes an index for the size of the gap formed between the outer peripheral surface of the electrode group and the inner peripheral surface of the battery case. In the battery with a high energy density, the battery case is packed with as many power generation elements as possible. Therefore, the gap is decreased, and the S1/S2 ratio approaches 1. The S1 and S2 can be determined by analysis of an X-ray computed tomographic image (X-ray CT image) of the wound-type battery. That is, S1 can be determined from an X-ray CT image of the completed battery provided with the electrode group impregnated with the nonaqueous electrolyte. The S1/S2 ratio can be calculated from brightness and darkness by binarization of the CT image.

From the viewpoint of enhancing the cushioning properties, the thickness T1 of the first organic layer is preferably as large as possible. Thus, T1 is preferably 10 μm or more and more preferably 20 μm or more. Also, the thickness T1 of the first organic layer is desirably larger than the thickness T2 of the second organic layer, and 1<T1/T2≤1.5 is more preferred and 1.1≤T1/T2≤1.5 is still more preferred. However, when the insulating tape is made excessively thick with an excessive increase in T1, the pressure applied to the electrode is increased, and the energy density of the battery is decreased. Therefore, the thickness T1 of the first organic layer is preferably 40 μm or less.

On the other hand, the effect of suppressing the extension of internal short-circuit is not so much influenced by the thickness T2 of the second organic layer, and thus T2 may be, for example, 5 μm or more. The excessively large thickness T2 of the second organic layer excessively increases the thickness of the insulating tape. Therefore, T2 is preferably 40 μm or less and more preferably 35 μm or less.

The first organic layer is preferably a polyolefin film. The polyolefin film is a resin film containing a polyolefin as a main component and has low heat resistance but has a low elastic modulus E1 and excellent cushioning properties. In particular, polypropylene is preferred in view of the tensile modulus (Young's modulus) at 20° C. of 112 to 158 kgf/mm², high cushioning properties, and the relatively high melting point (MP1) of 168° C. The polyolefin film may contain a resin component other than polyolefin and may contain a filler such as inorganic particles. However, from the viewpoint of enhancing the cushioning function, the content of polyolefin (particularly polypropylene) is preferably 90% by mass or more in the resin components contained in the polyolefin film.

The second organic layer is preferably a polyimide film. The polyimide film is a resin film containing polyimide as a main component and has high heat resistance and high elastic modulus E2. The polyimide has no melting point but has a thermal decomposition temperature (MP2) of 500° C. or more. Also, the tensile modulus (Young's modulus) at 20° C. of polyimide is 225 to 281 kgf/mm². The polyimide film may contain a resin component other than polyimide and may contain a filler such as inorganic particles. However, from the viewpoint of enhancing the function of suppressing the extension of an internal short circuit, the content of polyimide is preferably 90% by mass or more in the resin components contained in the polyimide film.

At least one (hereinafter, simply referred to as the “adhesive layer”) of the first adhesive layer and the second adhesive layer may contain an insulating inorganic filler in addition to the adhesive. This can improve the heat resistance of the adhesive layer and increase the electric resistance of the adhesive layer at high temperature. In particular, the second adhesive layer preferably has the function of improving the heat resistance and electric resistance rather than adhesiveness. Therefore, at least the second adhesive layer preferably contains the insulating inorganic filler.

From the viewpoint of enhancing the heat resistance and electric resistance, the content of the insulating inorganic filler in the second adhesive layer is preferably 20% by mass or more and more preferably 30% by mass or more. However, in view of adhesiveness, the content of the insulating inorganic filler in the second adhesive layer is preferably 50% by mass or less.

The nonaqueous electrolyte secondary battery with a high energy density represents a battery having a volume energy density of, for example, 500 Wh/L or more and particularly 600 Wh/L or more or 700 Wh/L or more. The volume energy density is a characteristic value obtained by dividing the product of the nominal voltage and the nominal capacity of the battery by the volume of the battery.

A lithium ion secondary battery according to an embodiment of the present invention is described in further detail below with reference to the drawings. Here, description is made assuming the case where the first electrode is a positive electrode and the second electrode is a negative electrode, but the present invention is not limited to this case and includes the case where the first electrode is a negative electrode and the second electrode is a positive electrode.

(Positive Electrode)

The positive electrode has a positive electrode current collector and a positive electrode active material layer supported by the positive electrode current collector. However, the positive electrode current collector is provided with an exposed portion not having the positive electrode active material layer. The exposed portion may be both-surface exposed portions not having the positive electrode active material layer on both surfaces of the positive electrode current collector, or a one-surface exposed portion not having the positive electrode active material layer on one of the surfaces of the positive electrode current collector (that is, the other surface has the positive electrode active material layer). The shape of the exposed portion is not particularly limited, but in the case of a strip electrode, the exposed portion preferably has a narrow slit shape crossing at an angle of 80 to 100 degrees with respect to the length direction of the positive electrode current collector. The slit-shaped exposed portion preferably has a width of 3 mm to 20 mm from the viewpoint of suppressing a decrease in energy density.

The positive electrode current collector preferably uses a sheet-shaped conductive material, particularly a metal foil. Preferred examples of the metal which forms the metal foil include aluminum, aluminum alloys, stainless steel, titanium, titanium alloys, and the like. The thickness of the positive electrode current collector is, for example, 1 to 100 μm and is preferably 10 to 50 μm.

The positive electrode active material layer of the lithium ion secondary battery contains a positive electrode active material, a conductive agent, a binder, etc. The positive electrode active material is a material which can be doped and dedoped with lithium ions, and, for example, a lithium composite oxide is preferably used. The lithium composite oxide contains a transition metal whose valence is changed by oxidation-reduction. Examples of the transition metal include vanadium, manganese, iron, cobalt, nickel, titanium, and the like. More specific examples thereof include LiCoO₂, LiMn₂O₄, LiNiO₂, LiNiₓ₁Mn_{y1}Co_{1-(x1+y1)}O₂, LiNiₓ₂CO_{y2}M_{1-(x2+y2)}O₂, αLiFeO₂, LiVO₂, and the like. Here, x1 and y1 satisfy 0.25≤x1≤0.5 and 0.25≤y1≤0.5, x2 and y2 satisfy 0.75≤x2≤0.99 and 0.01≤y2≤0.25, and M is at least one element selected from the group consisting of Na, Mg, Sc, Y, Ti, V, Cr, Fe, Cu, Ag, Zn, Al, Ga, In, Sn, Pb, and Sb.

In addition, carbon black, graphite, carbon fibers, or the like is used as the conductive agent contained in the positive electrode active material layer. The amount of the conductive agent is, for example, 0 to 20 parts by mass relative to 100 parts by mass of the positive electrode active material. A fluorocarbon resin, an acrylic resin, rubber particles, or the like is used as the binder contained in the active material layer. The amount of the binder is, for example, 0.5 to 15 parts by mass relative to 100 parts by mass of the active material.

The positive electrode active material layer is formed by kneading a positive electrode mixture containing the positive electrode active material, the binder, the conductive agent, etc. together with a dispersion medium to prepare a positive electrode paste, applying the positive electrode paste on a predetermined region of the surface of the positive electrode current collector, and then drying and rolling the paste. An organic solvent, water, or the like is used as the dispersion medium. For example, N-methyl-2-pyrrolidone (NMP) is preferably used as the organic solvent, but the organic solvent is not particularly limited. The positive electrode paste can be applied by using various coaters. Drying after application may be natural drying or drying under heating. The thickness of the positive electrode active material layer is, for example, 70 μm to 250 μm and preferably 100 μm to 200 μm.

The positive electrode current collector is provided with an exposed portion not having the positive electrode active material layer. In the case of the strip-shaped positive electrode, by intermittently applying the positive electrode paste on the positive electrode current collector, the exposed portion can be formed at the ends in the length direction of the positive electrode or regions other than the ends (for example, positions at a distance of 20% or more of the length of the positive electrode from both ends). In this case, the exposed portion is preferably a slit-shaped exposed portion in which the strip-shaped positive electrode current collector is exposed from one of the ends to the other end in the width direction. The exposed portion may be formed by peeling a portion of the positive electrode active material layer from the positive electrode.

Further, for example, a strip-shaped positive electrode lead (first lead) is electrically connected to the exposed portion. For example, in the positive electrode lead, at least a portion of a portion (overlapping portion) overlapping the exposed portion is bonded to the exposed portion by welding. Then, at least a portion (preferably 90% or more of the area of the exposed portion) of the exposed portion of the positive electrode current collector and at least a portion (preferably 90% or more of the area of the overlapping portion) of the overlapping portion of the positive electrode lead are together covered with the insulating tape.

Usable examples of a material of the positive electrode lead 13 include aluminum, aluminum alloys, nickel, nickel alloys, iron, stainless steel, and the like. The thickness of the positive electrode lead 13 is, for example, 10 μm to 120 μm and is preferably 20 μm to 80 μm. The size of the positive electrode lead 13 is not particularly limited, but is a strip shape having, for example, a width of 2 mm to 8 mm and a length of 20 mm to 80 mm.

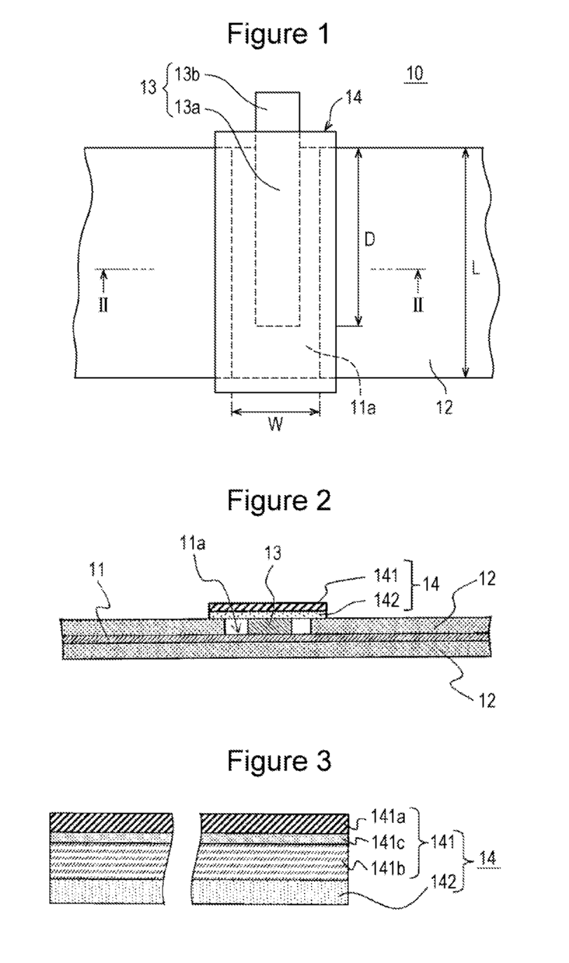

FIG. 1 is a plan view of a principal portion of a strip-shaped positive electrode according to an embodiment of the present invention, and FIG. 2 is a cross-sectional view of the positive electrode shown in FIG. 1, as viewed from arrows II-II. A strip-shaped positive electrode 10 has positive electrode active material layers 12 on both surfaces, excluding a portion, of a positive electrode current collector 11. Further, a slit-shaped exposed portion 11a is provided on one of the surfaces of the positive electrode current collector 11 so as to expose the positive electrode current collector 11 from one of the ends to the other end in the width direction. The width W of the exposed portion 11a depends on the size of the battery, but is generally larger than the width of the positive electrode lead 13 and is, for example, 3 mm to 20 mm and is preferably 5 mm to 16 mm. In addition, a portion of the overlapping portion 13a of the strip-shaped positive electrode lead 13 is welded to the exposed portion 11a. The length D (the distance from the boundary between the overlapping portion 13a and the lead-out portion 13b to the position most separated from the boundary in the overlapping portion 13a) of the overlapping portion depends on the size of the battery. The length D is, for example, 10 mm to 60 mm, which is 5% to 100%, preferably 20% to 95%, of the width L (length in the short direction) of the positive electrode current collector 11.

From the viewpoint of maximizing the effect of preventing an internal short-circuit, the insulating tape 14 covers the entire surface of the exposed portion 11a and covers the entire surface of the overlapping portion 13a of the positive electrode lead 13. The insulating tape 14 has a substrate layer 141 and a first adhesive layer 142 and is bonded to the exposed portion 11a through the first adhesive layer 142.

In order to securely cover the exposed portion 11a with the insulating tape 14, the insulating tape 14 is preferably projected from both ends of the positive electrode 10 in the width direction. The projecting width from at each of the ends of the positive electrode 10 is preferably 0.5 mm or more. Also, the projecting width from the positive electrode 10 is preferably 20 mm or less so as not to hinder an increase in energy density of the battery. Similarly, the insulating tape 14 is projected from both ends of the exposed portion 11a in the width direction on to the positive electrode active material layer 12. The projecting width from each of the ends on to the positive electrode active material layer 12 is preferably 0.5 mm or more and preferably 5 mm or less.

Next, the insulating tape is described in further detail.

As shown in FIG. 3, the insulating tape 14 has the substrate layer 141 and the first adhesive layer 142. The substrate layer 141 is provided with the first organic layer 141a, the second organic layer 141b, and the second adhesive layer 141c interposed between these organic layers.

The first organic layer 141a preferably contains polyethylene, polypropylene, an ethylene-propylene copolymer, or the like. Among these, polypropylene is preferred. When the first organic layer 141a is a polypropylene film, the polypropylene film may contain a material other than polypropylene and may be formed of a polymer alloy of polypropylene and a resin other than polypropylene. However, the content of polypropylene contained in the polypropylene film is preferably 90% by mass or more.

The second organic layer 141b preferably contains polyimide, polyamide, polyamide-imide, polyphenylene sulfide, or the like. Among these, polyimide, wholly aromatic polyamide (aramid), or the like is preferred, and polyimide is particularly preferred. When the second organic layer 141b is a polyimide film, the polyimide film may contain a material other than polyimide and may be formed of a polymer alloy of polyimide and a resin other than polyimide. However, the content of polyimide contained in the polyimide film is preferably 90% by mass or more.

The polyimide is a general term for polymers having a repeating unit containing an imide bond. Particularly preferred is an aromatic polyimide in which aromatic compounds are directly connected to each other with an imide bond. The aromatic polyimide has a conjugated structure in which an imide bond is interposed between an aromatic ring and an aromatic ring and has a rigid and strong molecular structure. The type of polyimide is not particularly limited and may be a wholly aromatic polyimide such as polypyromellit-imide or the like, a semi-aromatic polyimide such as polyether imide or the like, or a thermosetting polyimide produced by reaction of bismaleimide with an aromatic diamine.

Next, various resin materials can be used as the adhesive contained in each of the first adhesive layer and the second adhesive layer. Usable examples thereof include acrylic resins, natural rubber, synthetic rubber (butyl rubber and the like), silicone, epoxy resins, melamine resins, phenol resins, and the like. These may be used alone or in combination of a plurality of types. If required, the adhesive may contain additives, such as a tackifier, a crosslinking agent, an anti-aging agent, a coloring agent, an antioxidant, a chain transfer agent, a plasticizer, a softener, a surfactant, an antistatic agent, and the like, and a small amount of solvent. The same adhesive or different adhesives may be used for the first adhesive layer and the second adhesive layer. The compositions of the first adhesive layer and the second adhesive layer may be the same or different.

At least one of the first adhesive layer 142 and the second adhesive layer 141c may contain an insulating inorganic filler. A particle- or fiber-like metal compound is preferably used as the insulating inorganic filler, and the content of the metal compound in the insulating inorganic filler is preferably 90% by mass or more. In particular, metal compound particles are easily uniformly dispersed in the adhesive layer. The shape of the particles is not particularly limited and may be a spherical shape, a flake-like shape, a whisker-like shape, or the like. These insulating inorganic fillers may be used alone or in combination of a plurality of types.

Usable examples of the metal compound include metal oxides, metal nitrides, metal carbides, and the like. Among these, metal oxides are preferred because of high insulation and low cost. Examples of the metal oxides include alumina, titania, silica, zirconia, magnesia, and the like.

The average particle diameter of the metal compound particles may be properly designed according to the thickness of the adhesive layer. The average particle diameter (median diameter in a volume-based particle size distribution) of the metal compound particles is, for example, preferably 2 μm or less and more preferably 1 μm or less. In view of dispersibility in the adhesive layer, the average particle diameter of the metal compound particles is desirably 50 nm or more.

The thickness T_{ad1} of the first adhesive layer is, for example, preferably 5 μm to 15 μm or 5 μm to 10 μm. When the thickness T_{ad1} of the first adhesive layer is 5 μm or more, high adhesiveness and electric resistance can be easily secured. When the thickness T_{ad1} of the first adhesive layer is 15 μm or less, a thin insulating tape can be easily designed. On the other hand, the thickness T_{ad2} of the second adhesive layer is, for example, preferably 5 μm to 15 μm.

From the viewpoint of increasing the energy density of the battery, the thickness Tₐₗₗ of the insulating tape is preferably 80 μm or less and more preferably 70 μm or less. However, the excessively thin insulating tape may be insufficient in strength and insulation. In order to secure sufficient strength and insulation of the insulating tape, the thickness Tₐₗₗ of the insulating tape is preferably 20 μm or more and more preferably 30 μm or ore.

(Negative Electrode)

The negative electrode has a negative electrode current collector and a negative electrode active material layer supported by the negative electrode current collector. In general, the negative electrode current collector is provided with an exposed portion not having the negative electrode active material layer. For example, a strip-shaped negative electrode lead (second lead) may be connected to the exposed portion.

A sheet-shaped conductive material is used as the negative electrode current collector, and a metal foil is particularly preferred. Preferred examples of a metal which formed the metal foil include copper, copper alloys, nickel, nickel alloys, stainless steel, and the like. The thickness of the negative electrode current collector is, for example, 1 to 100 μm and preferably 2 to 50 μm.

The negative electrode active material layer of the lithium ion secondary battery contains a negative electrode active material, a binder, etc. The negative electrode active material is a material which can be doped and dedoped with lithium ions, and usable examples thereof include carbon materials (various types of graphite such as natural graphite, artificial graphite, and the like, mesocarbon microbeads, hard carbon, and the like), transition metal compounds which are doped and dedoped with lithium ions at a potential lower than the positive electrode, alloy-based materials, and the like. Examples of the alloy-based materials include silicon, silicon oxide, silicon alloys, tin, tin oxide, tin alloys, and the like. In particular, a combination of a carbon material and a silicon oxide is preferably used. The content of the alloy-based material in the negative electrode active material is preferably 5% by mass to 30% by mass, more preferably 10% by mass to 30% by mass, and still more preferably 15% by mass to 30% by mass.

A fluorocarbon resin, an acrylic resin, rubber particles, a cellulose resin (for example, carboxymethyl cellulose), or the like is used as the binder contained in the negative electrode active material layer. The amount of the binder is, for example, 0.5 to 15 parts by mass relative to 100 parts by mass of the active material.

The negative electrode active material layer is formed by kneading a negative electrode mixture containing the negative electrode active material and the binder, together with a dispersion medium, to prepare a negative electrode paste, applying the negative electrode paste on a predetermined region of the surface of the negative electrode current collector, and then drying and rolling the paste. Like in the positive electrode paste, an organic solvent, water, or the like is used as the dispersion medium. The negative electrode paste can be applied by the same method as for the positive electrode. The thickness of the negative electrode active material layer is, for example, 70 μm to 250 μm and preferably 100 μm to 200 μm.

(Nonaqueous Electrolyte)

The nonaqueous electrolyte is prepared by dissolving a lithium salt in a nonaqueous solvent. Examples of the nonaqueous solvent include cyclic carbonate such as ethylene carbonate, propylene carbonate, and the like; linear carbonates such as dimethyl carbonate, diethyl carbonate, ethyl methyl carbonate, and the like; lactone such as γ-butyrolactone and the like; linear carboxylic acid esters such as methyl formate, methyl acetate, and the like; halogenated alkanes such as 1,2-dichloroethane and the like; alkoxyalkanes such as 1,2-dimethoxyethane and the like; ketones such as 4-methyl-2-pentanone and the like; linear ethers such as pentafluoropropyl methyl ether and the like; cyclic ethers such as 1,4-dioxane, tetrahydrofuran, and the like; nitriles such as acetonitrile and the like; amides such as N,N-dimethylformamide and the like; carbamates such as 3-methyl-2-oxazolidone and the like; sulfur-containing compounds such as sulfoxides (sulfolane, dimethyl sulfoxide, and the like), 1,3-propanesultone, and the like; halogen-substituted products produced by substituting hydrogen atoms of these solvents with fluorine atoms; and the like. The nonaqueous solvents can be used alone or in combination of two or more.

Usable examples of the lithium salt include LiPF₅, LiBF₄, LiAsF₆, LiSbF₆, LiCF₃SO₃, LiN(CF₃SO₂)₂, LiN(C₂F₅SO₂)₂, LiN(CF₃SO₂) (C₄F₉SO₂), LiC(CF₃SO₂)₃, LiClO₄, LiAlCl₄, Li₂B₁₀Cl₁₀, and the like. These lithium salts can be used alone or in combination of two or more. The concentration of the lithium salt in the nonaqueous electrolyte is, for example, 0.5 to 1.7 mol/L and preferably 0.7 to 1.5 mol/L.

(Separator)

A resin-made microporous film, a nonwoven fabric, or the like can be used as the separator. Examples of the resin constituting the separator include polyolefins such as polyethylene, polypropylene, and the like; polyamide; polyamide-imide; polyimide; and the like. The thickness of the separator is, for example, 5 to 50 μm.

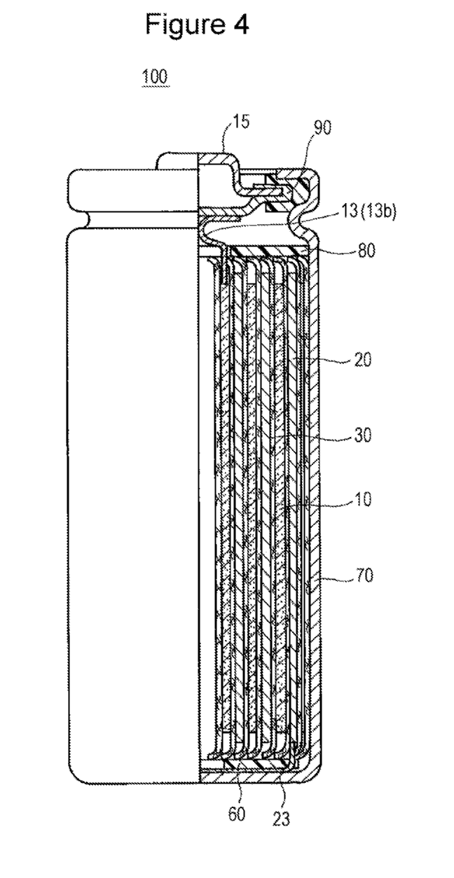

FIG. 4 is a longitudinal sectional view of an example of a cylindrical lithium ion secondary battery according to an embodiment of the present invention.

A lithium ion secondary battery 100 is a wound-type battery including a wound-type electrode group and a nonaqueous electrolyte not shown. The electrode group includes a strip-shaped positive electrode 10, a strip-shaped negative electrode 20, and a separator 30, a positive electrode lead 13 is connected to the positive electrode, and a negative electrode lead 23 is connected to the negative electrode. The figure shows only a lead-out portion 13b of the positive electrode lead 13, but does not show an overlapping portion and an insulating tape.

One of the ends of the positive electrode lead 13 is connected to the exposed portion of the positive electrode 10, and the other end is connected to a sealing plate 90. The sealing plate 90 is provided with a positive electrode terminal 15. One of the ends of the negative electrode lead 23 is connected to the negative electrode 20, and the other end is connected to the bottom serving as a negative electrode terminal of a battery case 70. The battery case 70 is a bottomed cylindrical battery case in which one of the ends in the longitudinal direction is open, and the bottom at the other end serves as the negative electrode terminal. The battery case (battery can) 70 is made of a metal and is, for example, made of iron. The inner surface of the iron-made battery case 70 is generally plated with nickel. In addition, an upper insulating plate 80 and a lower insulating plate 60 each of which is made of a resin are disposed above and below the electrode group so as to hold the electrode group therebetween.

The shape of the battery is not limited to a cylindrical shape and may be, for example, a prismatic shape or a flat shape. The battery case may be formed of a laminate film.

### EXAMPLES

The present invention is described in further detail below based on examples. However, the present invention is not limited to these examples.

### Example 1

(1) Formation of Positive Electrode

A positive electrode paste was prepared by mixing 100 parts by mass of LiNi_{0.82}Co_{0.15}Al_{0.03}O₂ used as a positive electrode active material, 1.0 parts by mass of acetylene black, 0.9 parts by mass of polyvinylidene fluoride (binder), and a proper amount of NMP. The resultant positive electrode paste was uniformly applied on both surfaces of an aluminum foil having a thickness of 20 μm and used as a positive electrode current collector, dried, and then rolled to form a strip-shaped positive electrode having a width of 58 mm. In addition, a slit-shaped exposed portion was provided on both surfaces of the positive electrode near the center in the longitudinal direction thereof so as to expose the positive electrode current collector from one of the ends to the other end in the width direction. The width W of the exposed portion was 6.5 mm.

Next, a strip-shaped positive electrode lead made of aluminum and having a width of 3.5 mm and a length of 68 mm was overlapped with the exposed portion of the positive electrode current collector and positioned so that the length of a lead-out portion was 15 mm and the length (length D) of an overlapping portion was 53 mm. Then, the overlapping portion was welded to the exposed portion.

Then, an insulating tape was attached to the positive electrode so as to cover the entire surface of the exposed portion and the entire surface of the overlapping portion. In this case, in order to securely cover the exposed portion with the insulating tape, the insulating tape was projected 2 mm from each of both ends in the width direction of the positive electrode. Also, the insulating tape was projected 2 mm on to the positive electrode active material layer from each of both ends in the width direction of the exposed portion.

Here, the insulating tape (total thickness of 67 μm) having a substrate layer with a thickness of 60 μm and a first adhesive layer with a thickness of 7 μm was used. The substrate layer was provided with a polypropylene (PP) film (first organic layer) having a thickness of 30 μm and containing 100% polypropylene, a polyimide (PI) film (second organic layer) having a thickness of 25 μm and containing 100% polyimide, and a second adhesive layer having a thickness of 5 μm and interposed between the first organic layer and the second organic layer.

The tensile modulus (E1) of PP was 130 kgf/mm², and the tensile modulus (E2) of PI was 250 kgf/mm².

A non-thermoplastic polyimide having a skeleton represented by formula (1) below was used as the polyimide. The polyimide having a structure shown below is synthesized by, for example, reaction of pyromellitic anhydride with diaminodiphenyl ether.

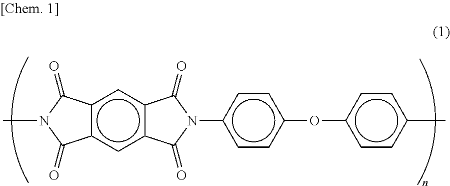

An acrylic adhesive containing an acrylic resin as a main component was used for each of the first adhesive layer and the second adhesive layer.

(2) Formation of Negative Electrode

A negative electrode paste was prepared by mixing 100 parts by mass of a flake-shaped artificial graphite having an average particle diameter of about 20 μm and used as a negative electrode active material, 1 parts by mass of styrene butadiene rubber (SBR) (binder), 1 part by mass of carboxymethyl cellulose (thickener), and water. The resultant negative electrode paste was uniformly applied on both surfaces of a copper foil of 8 μm in thickness, which was used as a negative electrode current collector, dried, and then rolled to form a strip-shaped negative electrode having a width of 59 mm. In addition, an exposed portion was provided on both surfaces of the negative electrode at the winding end-side end so as to expose the negative electrode current collector from one of the ends to the other end in the width direction.

Next, a strip-shaped negative electrode lead made of nickel and having a width of 3 mm and a length of 40 mm was overlapped with the exposed portion of the negative electrode current collector and positioned by the same method as for the positive electrode. Then, the overlapping portion was welded to the exposed portion.

(3) Formation of Electrode Group

The positive electrode and the negative electrode were laminated with the separator interposed therebetween and then wound to form an electrode group. In this case, as shown in FIG. 4, the lead-out portion of the positive electrode lead was projected from one of the ends of the electrode group, and the lead-out portion of the negative electrode lead was projected from the other end.

(4) Preparation of Nonaqueous Electrolyte

A nonaqueous electrolyte was prepared by dissolving LiPF₆ so that the concentration was 1.4 mol/L in a mixed solvent of ethylene carbonate, ethylmethyl carbonate, and dimethyl carbonate (volume ratio of 1:1:8).

(5) Formation of Battery

The electrode group held between a lower insulating ring and an upper insulating ring was housed in an iron-made battery case (diameter: 18 mm, height: 65 mm) having the inner surface plated with nickel. The negative electrode lead was interposed between the lower insulating ring and the bottom of the battery case. Also, the positive electrode lead was passed through a through hole at the center of the upper insulating ring. Next, an electrode rod was passed through the central hollow portion of the electrode group and the central through hole of the lower insulating ring, and one of the ends of the negative electrode lead was welded to the inner surface of the bottom of the battery case. Also, the end of the positive electrode lead led out from the through hole of the upper insulating ring was welded to the inner surface of the sealing plate provided with a gasket at the periphery thereof. Then, a groove was formed near the opening of the battery case, and the nonaqueous electrolyte was injected into the battery case and impregnated into the electrode group. Next, the opening of the battery case was closed with the sealing plate, and the end of the opening of the battery case was caulked to the peripheral portion of the sealing plate through the gasket, thereby completing a cylindrical nonaqueous electrolyte secondary battery (energy density of 700 Wh/L). In this case, the ratio of S1/S2 of the cross-sectional area S1 of the electrode group to the cross-sectional area of the region surrounded by the inner peripheral surface of the battery case was 0.97.

### Example 2

A battery was formed by the same method as in Example 1 except that a second adhesive layer was not formed for bonding together a polypropylene film (first organic layer) and a polyimide film (second organic layer), and the polypropylene film and the polyimide film were heat-welded at 180° C. The thickness of the substrate layer as 55 μm.

### Example 3

A battery was formed by the same method as in Example 1 except that an insulating inorganic filler was dispersed in a second adhesive layer. In this example, a mixture of 80 parts by mass of an acrylic adhesive and 20 parts by mass of alumina particles (average particle diameter of 0.7 μm) was used for the second adhesive layer.

### Example 4

A battery was formed by the same method as in Example 3 except that polyphenylene sulfide (PPS) was used in place of the polyimide film as the second organic layer. The tensile modulus (E2) of PPS was 337 kgf/mm², and the melting point (MP2) was 290° C.

### Comparative Example 1

A battery was formed by the same method as in Example 3 except that the arrangement of a polyimide film and a polypropylene film was reversed, and a first adhesive layer was formed in the polypropylene film. Therefore, the polypropylene film was closer to the surface the positive electrode than the polyimide film.

### Comparative Example 2

A battery was formed by the same method as in Example 1 except that the thickness of a polyimide film was changed to 55 μm, and a polypropylene film and a second adhesive layer were not provided in the substrate.

### Comparative Example 3

A battery was formed by the same method as in Example 1 except that the thickness of a polypropylene film was changed to 55 μm, and a polyimide film and a second adhesive layer were not provided in the substrate.

The configurations of insulating tapes are summarized in Table 1.

TABLE 1

| | | | Evaluation |
|---|---|---|---|
| | Substrate layer | | Piercing |
| | Material | Second adhesive layer | strength (N) |
| Example 1 | PP/PI | Adhesive | 16.5 |
| Example 2 | PP/PI | No | 16.5 |
| Example 3 | PP/PI | Adhesive/filler | 17.6 |
| Example 4 | PP/PPS | Adhesive/filler | 15.4 |
| Comparative Example 1 | PI/PP | Adhesive/filler | 14.3 |
| Comparative Example 2 | PI | No | 13.0 |
| Comparative Example 3 | PP | No | 10.0 |

[Evaluation]

(Piercing Strength)

According to JIS Z 1707 (1998), the piercing strength of the insulating tape was measured.

Specifically, a needle having a diameter of 1.0 mm and a tip shape with a semicircular shape having a radius of 0.5 mm was pierced the insulating tape at a rate of 50 mm/min from the outer side without the first adhesive layer of the substrate layer, and the maximum stress until the needle pierced through the insulating tape was measured as piercing strength. The test results are shown in Table 1.

Table 1 indicates that in using any one of the insulating tapes of Comparative Examples 1 to 3, the piercing strength is low, while in using any one of the insulating tapes of Examples 1 to 4, the piercing strength is significantly improved. Also, a comparison between Example 3 and Comparative Example 1 indicates that when the arrangement of the polypropylene film and the polyimide film is reversed, the piercing strength is greatly changed.

In the embodiments described above, description is made of the case where the substrate layer includes a two-layer resin film having the first organic layer and the second organic layer, but the resin film may have three or more layers. In this case, a third resin film may be laminated on the surface opposite to the second organic layer-side surface of the first organic layer.

### INDUSTRIAL APPLICABILITY

A nonaqueous electrolyte secondary battery according to the present invention is preferably used as a drive source for electronic apparatuses such as a note personal computer, a cellular phone, and the like, and a power supply for a power storage apparatus required to have high output, an electric vehicle, a hybrid car, an electric tool, and the like.

### REFERENCE SIGNS LIST

10 positive electrode

11 positive electrode current collector

11a exposed portion of positive electrode current collector

12 positive electrode active material layer

13 positive electrode lead

13a overlapping portion

13b lead-out portion

14 insulating tape

141 substrate layer

141a first organic layer

141b second organic layer

141c second adhesive layer

142 first adhesive layer

15 positive electrode terminal

20 negative electrode

23 negative electrode lead

30 separator

60 lower insulating plate

70 battery case

80 upper insulating plate

90 sealing plate

100 lithium ion secondary battery

1. A nonaqueous electrolyte secondary battery comprising:
a first electrode having a first current collector and a first active material layer supported by the first current collector;
a second electrode having a second current collector and a second active material layer supported by the second current collector;
a separator interposed between the first electrode and the second electrode;
a nonaqueous electrolyte;
a first lead electrically connected to the first electrode; and
an insulating tape which covers a portion of the first electrode,
wherein the first current collector has an exposed portion which does not support the first active material layer, and the first lead is connected to the exposed portion;
the first lead has a lead-out portion projecting from the exposed portion and an overlapping portion overlapping the exposed portion;
at least a portion of the exposed portion of the first current collector, together with at least a portion of the overlapping portion of the first lead, is covered with the insulating tape;
the insulating tape has a substrate layer and a first adhesive layer;
the substrate layer has a first organic layer and a second organic layer interposed between the first organic layer and the first adhesive layer; and
an elastic modulus E1 of the first organic layer is lower than an elastic modulus E2 of the second organic layer.

2. The nonaqueous electrolyte secondary battery according to claim 1, wherein the energy density is 500 Wh/L or more.

3. The nonaqueous electrolyte secondary battery according to claim 1, wherein the thickness T1 of the first organic layer is larger than the thickness T2 of the second organic layer.

4. The nonaqueous electrolyte secondary battery according to claim 1, wherein the first organic layer is a polypropylene film.

5. The nonaqueous electrolyte secondary battery according to claim 1, wherein the second organic layer is a polyimide film.

6. The nonaqueous electrolyte secondary battery according to claim 1, wherein a second adhesive layer is provided between the first organic layer and the second organic layer.

7. The nonaqueous electrolyte secondary battery according to claim 6, wherein the second adhesive layer contains 20% by mass or more of an insulating inorganic filler.

8. A insulating tape for a secondary battery comprising:
a substrate layer has a first organic layer and a second organic layer interposed between the first organic layer and a first adhesive layer; and
a elastic modulus E1 of the first organic layer is lower than a elastic modulus E2 of the second organic layer.

9. The insulating tape for the secondary battery according to claim 8, wherein the thickness T1 of the first organic layer is larger than the thickness T2 of the second organic layer.

10. The insulating tape for the secondary battery according to claim 8, wherein the first organic layer is a polypropylene film.

11. The insulating tape for the secondary battery according to claim 8, wherein the second organic layer is a polyimide film.

12. The insulating tape for the secondary battery according to claim 8, wherein a second adhesive layer is provided between the first organic layer and the second organic layer.

13. The insulating tape for the secondary battery according to claim 12, wherein the second adhesive layer contains 20% by mass or more of an insulating inorganic filler.
